(19) United States
(12) Patent Application Publication
(10) Pub. No.: US 2010/0064478 A1
(43) Pub. Date: Mar. 18, 2010

(54) HINGE ASSEMBLY FOR PORTABLE ELECTRONIC DEVICES

(75) Inventors: CHAO DUAN, Shenzhen City (CN); CHIA-HUA CHEN, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/260,899

(22) Filed: Oct. 29, 2008

(30) Foreign Application Priority Data
Sep. 12, 2008 (CN) 200810304495.1

(51) Int. Cl. E05D 7/00

(52) U.S. Cl. 16/307

(57) ABSTRACT

A hinge assembly (100) includes a main shaft (10), a first positioning mechanism (14, 20), a second positioning mechanism (30, 40) and an elastic element (50). The first positioning mechanism is placed around the main shaft and has portions rotatable relative to the main shaft and portions not rotatable relative to the main shaft. The second positioning mechanism is placed around the main shaft and has portions rotatable relative to the main shaft and portions not rotatable relative to the main shaft. The elastic member is placed around the main shaft, and is disposed between the first positioning mechanism and the second positioning mechanism. The elastic member provides an elastic force to bias the rotatable portions of the first positioning mechanism and the second positioning mechanism against rotating relative to the main shaft.

### BACKGROUND

1. Field of the Invention

The present invention relates to hinge assemblies and, particularly, to hinge assemblies for portable electronic devices, such as mobile phones and portable computers.

2. Description of Related Art

Presently, the most popular electronic device in the marketplace is the foldable mobile phone, which generally includes a cover section and a body section. The cover section and the body section are rotatably connected to each other using a hinge assembly, for switching the mobile phone between an open (in-use) position and a closed position.

Hinge assemblies often include different followers and cams. The cam generally engages with the cover section, and the follower engages with the body section. However, since only a cam or follower supports the cover, the opening or closing of the hinge assembly can be difficult. In addition, the cam or the follower often needs to be made from a high strength material such as metal. This results in higher costs.

Therefore, there is room for improvement within the art.

### BRIEF DESCRIPTION OF THE DRAWINGS

Many aspects of the present hinge assembly can be better understood with reference to the following drawings. The components in the drawings are not necessarily drawn to scale, the emphasis instead being placed upon clearly illustrating the principles of the present hinge assembly. Moreover, in the drawings, like reference numerals designate corresponding parts throughout the several views, in which:

FIG. 1 is an exploded, isometric view of a first exemplary hinge assembly;

FIG. 2 is similar to FIG. 1, but viewed from another aspect;

FIG. 3 is a partially assembled, isometric view of the exemplary hinge assembly shown in FIG. 1;

FIG. 4 is an assembled, isometric view of the exemplary hinge assembly shown in FIG. 1; and

FIG. 5 is a cut-away view of FIG. 4;

FIG. 6 is an isometric view of an embodiment of the hinge assembly, as used in a mobile phone.

### DETAILED DESCRIPTION OF THE EMBODIMENTS

The present hinge assembly is suitable for a portable electronic device such as a flip-type mobile phone, for pivotably coupling a cover section to a body section. It is to be understood, however, that the hinge assembly could be advantageously used in other diverse environments (e.g. cabinet doors).

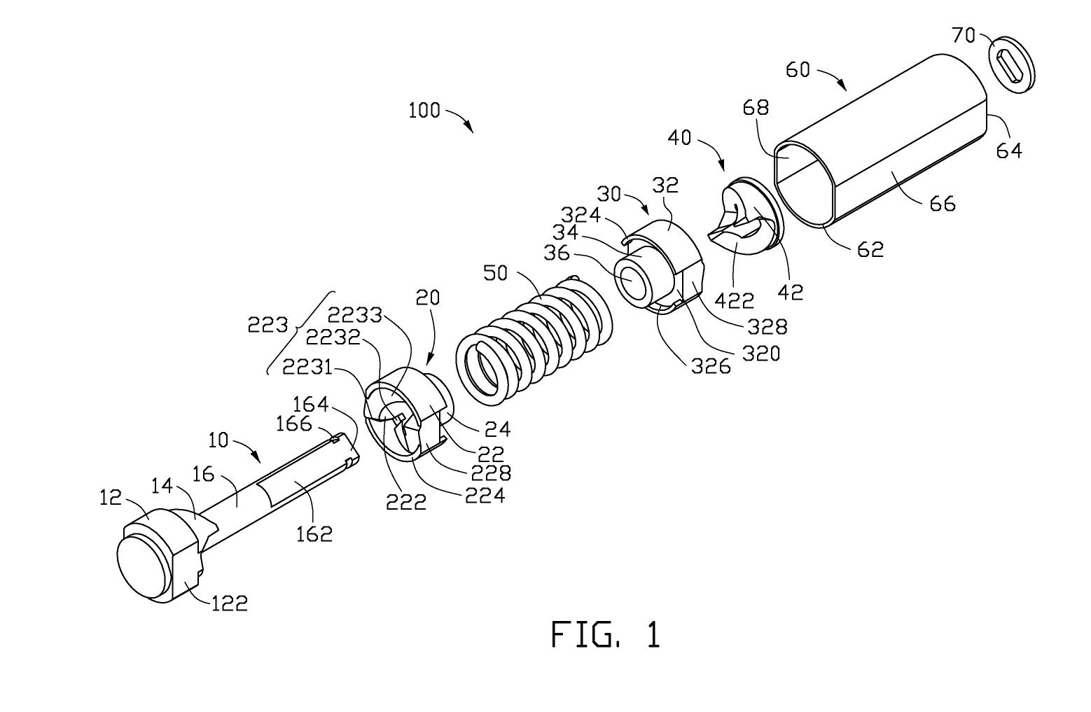

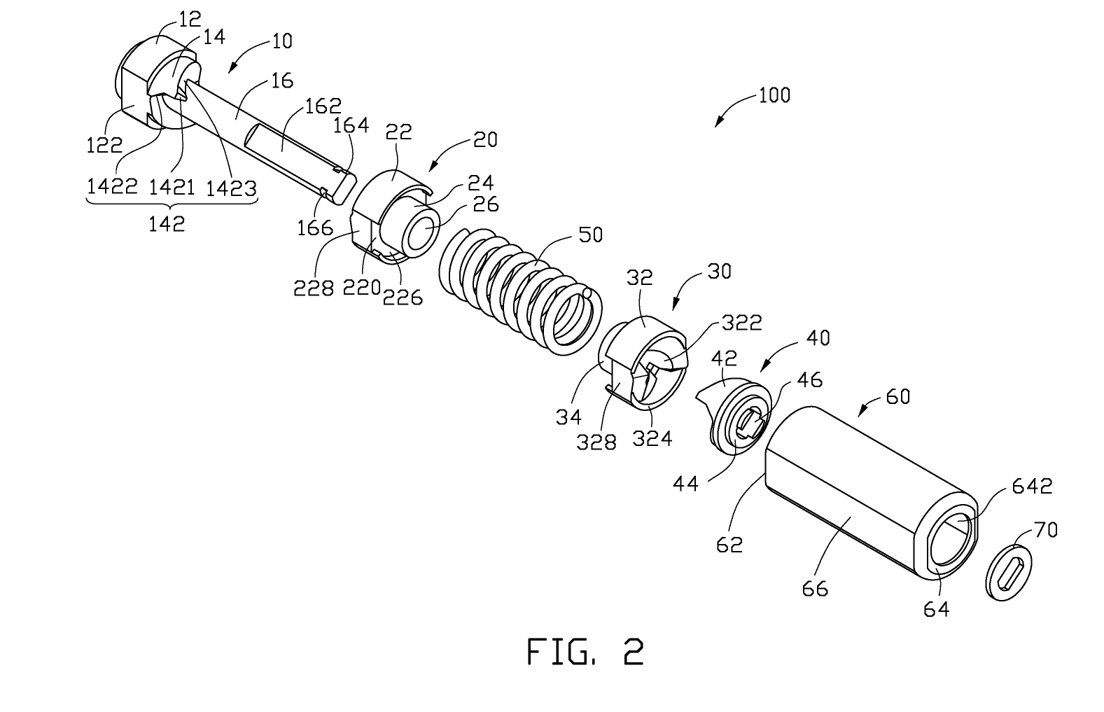

Referring to FIGS. 1 and 2, an exemplary hinge assembly 100 includes a main shaft 10, a first rotary element 20, a second rotary element 30, a follower 40, an elastic element 50, a sleeve 60 and a washer 70. As will be described below, portions of the main shaft 10 and first rotary element 20 form a first positioning mechanism and portions of the second rotary element 30 and follower 40 form a second positioning mechanism.

The main shaft 10 includes coaxially a mounted portion 12, a follower portion 14 and a shaft portion 16. The mounted portion 12 is formed at an end of the main shaft 10, and forms two planner surfaces 122 for connecting with a body section. The follower portion 14 extends from a side of the mounted portion 12 and is part of the first positioning mechanism. A diameter of the follower portion 14 is smaller than the diameter of the mounted portion 12. The follower portion 14 has a cam surface 142 including two symmetric peaks 1421, two symmetric valleys 1422, and slopes 1423 connected therebetween. The valleys 1422 are adjacent to the mounted portion 12. Understandably, the follower portion 14 may be made of thumb-shaped protrusions, spaced apart from each other by an angle of about 180 degrees. The shaft portion 16 extends from a middle of the follower portion 14. The shaft portion 16 forms two surfaces 162. The shaft portion 16 has a latching end 164 at a distal thereof. The latching end 164 defines a loop groove 166.

The first rotary element 20 can be made of a plastic material. The first rotary element 20 is substantially cylindrical, and includes a main body 22 and a connecting portion 24. A diameter of the main body 22 is larger than the diameter of the connecting portion 24, thereby forming an annular blocking surface 220. A through hole 26 is defined in the main body 22 and the connected portion 24. The first rotary element 20 is placed around the main shaft 10 using the through hole 26 and rotatable relative to main shaft 10. The main body 22 includes a cam portion 222 and a ring portion 224. The cam portion 222 is recessed in the main body 22, and surrounded by the ring portion 224. The cam portion 222 has a cam surface 223. The cam surface 223 includes two peaks 2231, two valleys 2232, and slopes 2233 connected therebetween. The cam surface 223 engages with the cam surface 142 of the main shaft 10 as part of the first positioning mechanism. In this exemplary embodiment, when the follower portion 14 is engaged with the cam portion 222, the follower portion 14 may be completed received in the ring portion 224, resulting in the ring portion 224 abutting a surface of the mounted portion 12. Accordingly, the distance between the follower portion 14 and the cam portion 222 is reduced, resulting in a more compact structure. The ring portion 224 extends some distance relative to the blocking surface 220, thereby surrounding a receiving cavity 226. The ring portion 224 forms two flat surfaces 228 along a peripheral wall thereof for connecting with a cover section (not shown).

The configuration and material of the second rotary element 30 is similar to the first rotary element 20. The first rotary element 30 also includes a main body 32 and a connecting portion 34. A blocking surface 320 is formed between the main body 32 and the connecting portion 34. A through hole 36 is defined in the main body 32 and the connecting portion 34. The main body 32 includes a cam portion 322 and a ring portion 324. The ring portion 324 with the blocking surface 320 surrounds a receiving cavity 326. The ring portion 224 forms two flat surfaces 328 along a peripheral wall thereof for connecting with a cover section.

The follower 40 is substantially cylindrical, and includes a latching cam portion 42 and a fixed portion 44. A diameter of the latching cam portion 42 is larger than the diameter of the fixed portion 44. The follower 40 defines a rectangular passage 46 for slidably receiving the shaft portion 16 such that the follow 40 is not rotatable relative to the main shaft 10. The cam portion 42 forms a cam surface 422 opposite to the fixed portion 44. The cam surface 422 engages with the cam portion 322 of the second rotary element 30 as part of the second positioning mechanism. Similarly, when the follower 40 is engaged with the cam portion 322, the cam portion 422 of the follower 40 may be completely received in the cam portion 322 so that the ring portion 324 may resist a brim of the follower 40. Accordingly, the distance between the follower 40 and the cam portion 322 is reduced, resulting in a more compact structure.

The elastic element 50 is preferably made of metal and is spiral-shaped (i.e. a coil spring). One end of the elastic element 50 resists the blocking wall 220 of the first rotary element 20, and is received in the receiving cavity 226. The other end of the elastic element 50 resists the blocking wall 320, and is received in the receiving cavity 326. An inner diameter of the elastic element 50 is slightly larger than a diameter of the shaft portion 16 so the elastic element 50 can be placed around the main shaft 10.

The sleeve 60 is substantially a hollow cylinder. The sleeve 60 includes an open end 62 and a partially-closed end 64. The partially-closed end 64 has a central hole 642. The sleeve 60 forms two symmetric flat surfaces 66 along an outer peripheral wall thereof configured for fixing with a cover section. Correspondingly, two guide grooves 68 are defined an inner wall of the sleeve 60.

The washer 70 is made of metal, and is placed around the latching end 164. In this exemplary embodiment, the washer 70 is locked in the loop groove 166 for avoiding the elements detaching from the main shaft 10.

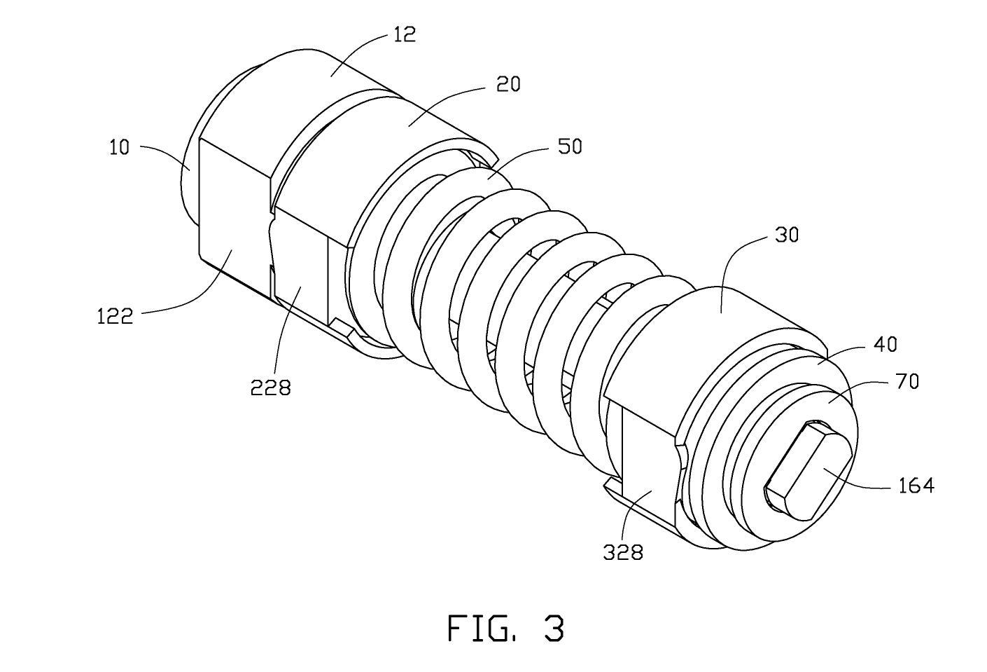

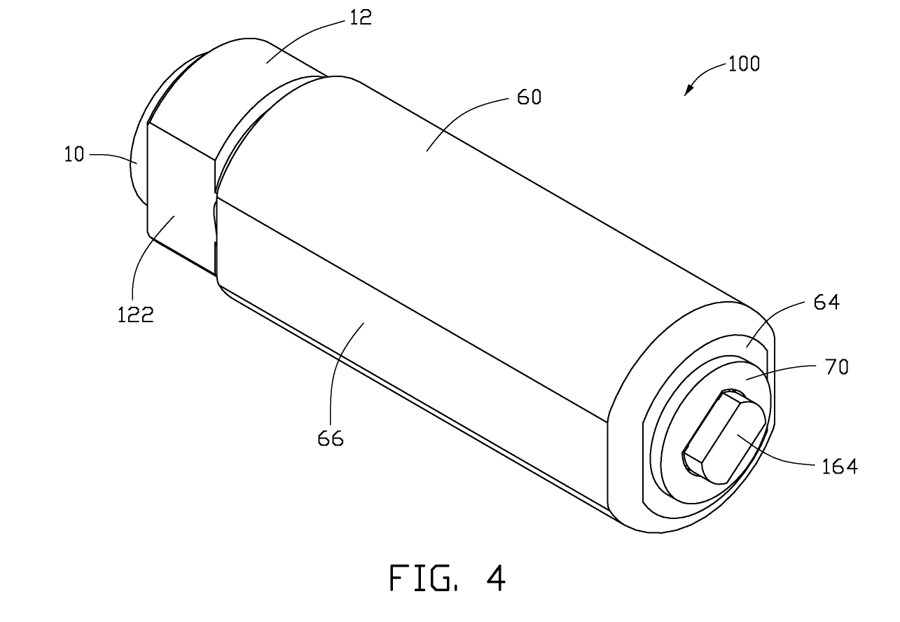

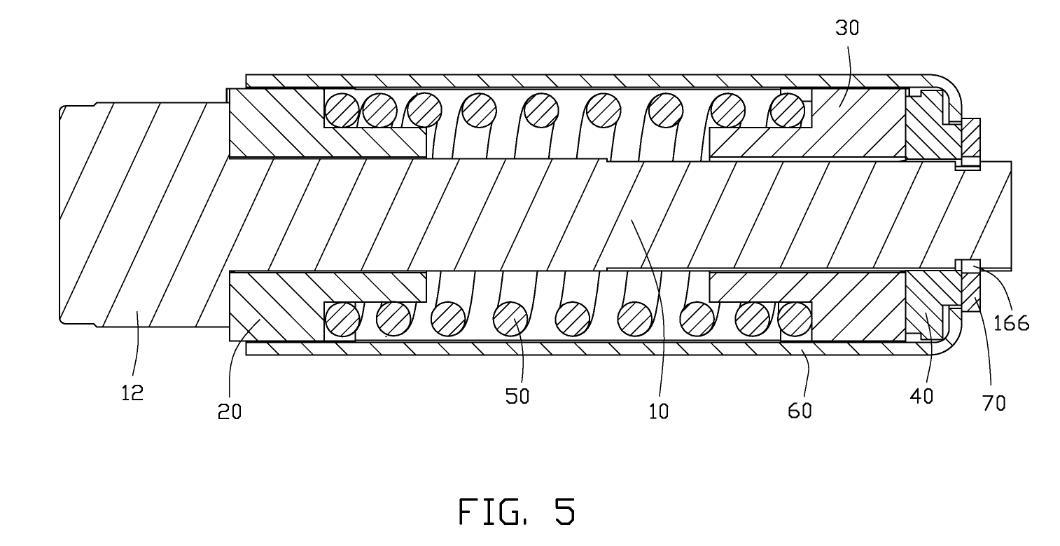

Referring to FIGS. 3 to 5, during assembly of the hinge assembly 100, the main shaft 10 is firstly inserted through the through hole 26 of the first rotary element 20. The cam portion 222 is further pushed to bias the follower portion 14. The elastic element 50 is placed around the main shaft 10. One end of the elastic element 50 resists the blocking surface 220 of the first rotary element 20, and one end is partially received in the receiving cavity 226. Next, the second rotary element 30 is placed around the main shaft 10. The other end of the elastic element 50 is received in the receiving cavity 326. Then, the follower 40 is placed around the main shaft 10, and the cam portion 42 is engaged with the cam portion 322.

The main shaft 10 with the above elements along the latching end 164 is inserted into the sleeve 60 from the open end 62. The first rotary element 20, the elastic element 50, the second rotary element 30 and the follower 40 are received in the sleeve 60. The flat surfaces 228, 328 are non-rotatably engaged in the guide grooves 68. The follower 40 resists the partially-closed end 64 of the sleeve 60. The fixed portion 44 is received in the central hole 642 of the partially-closed end 64. The latching end 164 extends from the central hole 642 of the partially-closed end 64. Finally, the washer 70 is locked in the loop groove 166 of the main shaft 10, thereby securing the above elements on the main shaft 10. The compact hinge assembly 100 is completely assembled.

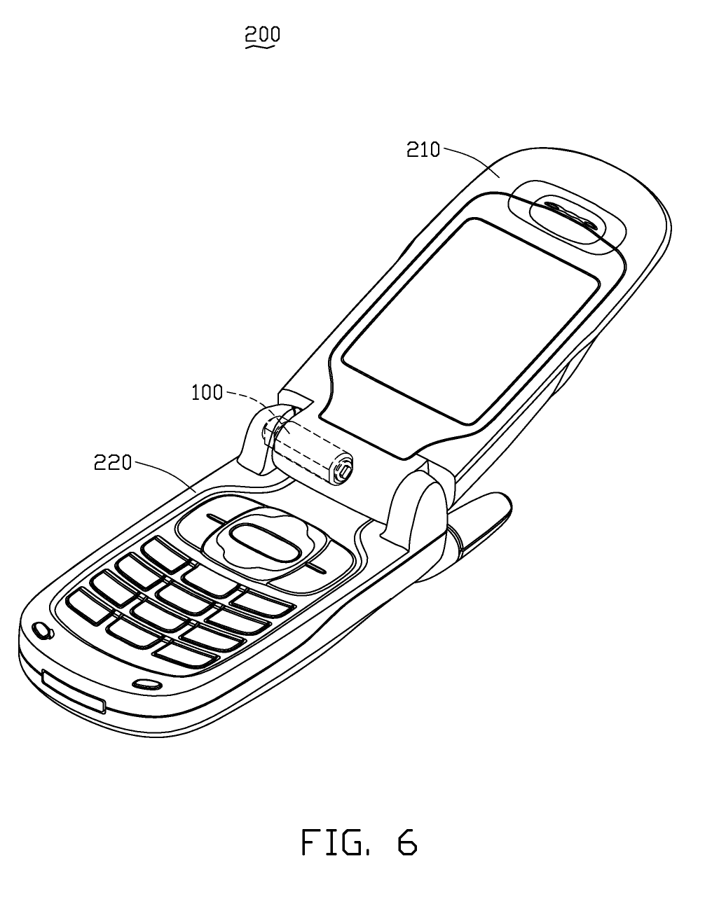

Referring to FIG. 6, the hinge assembly 100 is assembled in a foldable electronic device such as mobile phone 200 including a cover section 210 and a body section 220. When the mounted portion 12 of the main shaft 10 is pushed until the mounted portion 12 is completely received in the sleeve 60, the hinge assembly 100 is placed in a barrel of the cover section 210. The flat surfaces 66 of the sleeve 60 are fixed to the barrel of the cover section 210 of the mobile phone 200. Then, the mounted portion 12 is aligned with a mounted hole of the body section 220. When the mounted portion 12 is released, the mounted portion 12 automatically bounds in the body section 220. The planar faces 122 of the mounted portion 12 are fixed to the body section 220 of the mobile phone 200. At an initial state, the follower portion 14 is rotatably engageable with the cam surface 223 of the first rotary element 20, and the cam portion 322 of the second rotary element 30 is rotatably engageable with the cam surface 422 of the follower 40. The elastic member 50 has a predetermined compressed force, and the cover section 210 is held in a closed position where the rotatable portions of the first positioning mechanism and the second positioning mechanism are biased against rotating relative to the main shaft 10.

To open the mobile phone 200, the cover section 210 is manually rotated relative to the body section 220 in an opening direction. The sleeve 60 further moves together with the cover section 210. The first and second rotary elements 20, 30 rotate with the sleeve 60. The first rotary element 20 slides and rotates relative to the follower portion 14. Since the follower portion 14 and the follower 40 cannot move, the first and second rotary elements 20, 30 slide and rotate relative to the follower portion 14 and the follower 40, respectively, along the shaft portion 16. During this process, the elastic element 50 is further compressed until the peaks 2231 slides over the peaks 1421. The peaks of the second rotary element 30 slide over the peaks of the follower 40. The cover section 210 is released. The first, second rotary elements 20, 30 continue to slide in the open direction with the assistance of the force from the elastic element 50. The cover section 210 continues to open until the peaks of the first and second rotary elements 20, 30 move into other valleys of the follower portion 14 and the follower 40. Alternatively, the cover section 210 continues to open until contact between portions of the body section 220 and cover section 210 stabilizes the positioning of the cover section 210. At this time, the peaks may be at any location on the sloping surface. The closing process of the mobile phone 200 is opposite to the opening process and not detailed herein.

By the exemplary hinge assembly having two rotary elements to connect with the cover section, the opening process is relatively easy. Additionally, by the two rotary elements sharing torsion forces from the cover section, the strength requirement for the rotary elements may be decreased. Therefore, the rotary elements may be made by a lower strength material.

Understandably, the cam portion and the follower portion of the two positioning mechanism may be replaced with other configuration. In addition, the first rotary element and the second rotary element may adopt different structures.

It is to be understood that the elastic element may alternatively be made of another material (e.g. plastic or rubber). The elastic member may alternatively have a different configuration, for example, a leaf spring or a resilient cylinder.

It is believed that the present embodiments and their advantages will be understood from the foregoing description, and it will be apparent that different changes may be made thereto without departing from the spirit and scope of the invention or sacrificing all of its material advantages, the examples hereinbefore described merely being preferred or exemplary embodiments of the invention.

What is claimed is:

1. A hinge assembly, comprising:
a main shaft;
a first positioning mechanism placed around the main shaft and having portions rotatable relative to the main shaft and portions not rotatable relative to the main shaft; and
a second positioning mechanism placed around the main shaft and having portions rotatable relative to the main shaft and portions not rotatable relative to the main shaft;
an elastic member placed around the main shaft, and disposed between the first positioning mechanism and the second positioning mechanism, the elastic member providing an elastic force to bias the rotatable portions of the first positioning mechanism and the second positioning mechanism against rotating relative to the main shaft.

2. The hinge assembly as claimed in claim 1, wherein the first positioning mechanism includes a follower portion disposed on the main shaft and a first rotary element having a cam portion rotatably engaging the follower portion.

3. The hinge assembly as claimed in claim 1, wherein the second positioning mechanism includes a second rotary element and a follower, the second rotary element having a cam portion, the follower having a cam portion, and the cam portion of the second rotary element rotatably engages the cam portion of the follower.

4. The hinge assembly as claimed in claim 1, wherein the first rotary element includes a ring portion, the cam portion surrounded by the ring portion.

5. The hinge assembly as claimed in claim 1, wherein the main shaft includes a mounted portion, a follower portion and a shaft portion coaxially arranged with each other, and a portion of the first positioning mechanism rotatably engaging the follower portion.

6. The hinge assembly as claimed in claim 5, wherein a diameter of the follower portion is smaller than the diameter of the mounted portion.

7. The hinge assembly as claimed in claim 6, wherein the follower portion has a cam surface including two symmetric peaks, two symmetric valleys, and slopes connected the peaks and valleys, the valleys are adjacent to the mounted portion.

8. A foldable electronic device, comprising:
a cover section;
a body section; and
a hinge assembly rotatably connecting the cover section and the body section, the hinge assembly comprising:
a first positioning mechanism placed around the main shaft and having portions rotatable relative to the main shaft and portions not rotatable relative to the main shaft; and
a second positioning mechanism placed around the main shaft and having portions rotatable relative to the main shaft and portions not rotatable relative to the main shaft;
an elastic member placed around the main shaft, and disposed between the first positioning mechanism and the second positioning mechanism, the elastic member providing an elastic force to bias the rotatable portions of the first positioning mechanism and the second positioning mechanism against rotating relative to the main shaft.

9. The foldable electronic device as claimed in claim 8, further comprising a sleeve, wherein the sleeve has an open end and a partially-closed end, the first positioning mechanism and the second positioning mechanism are received in the sleeve.

10. The foldable electronic device as claimed in claim 9, further comprising a locking member, wherein the locking member is non-rotatably disposed at one end of the main shaft.

11. The foldable electronic device as claimed in claim 8, wherein the first positioning mechanism includes a follower portion disposed on the main shaft and a first rotary element having a cam portion rotatably engaging with the follower portion.

12. The foldable electronic device as claimed in claim 11, wherein the second positioning mechanism includes a second rotary element and a follower, the second rotary element having a cam portion, the follower having a latching cam portion, the cam portion of the second rotary element rotatably engages the latching cam portion of the follower.

13. The foldable electronic device as claimed in claim 12, wherein the first rotary element includes a ring portion, the cam portion surrounded by the ring portion.

14. The foldable electronic device as claimed in claim 8, wherein the main shaft includes a mounted portion, a follower portion and a shaft portion coaxially arranged with each other, and a portion of the first positioning mechanism rotatably engaging the follower portion.

15. The foldable electronic device as claimed in claim 14, wherein a diameter of the follower portion is smaller than the diameter of the mounted portion.

16. The foldable electronic device as claimed in claim 15, wherein the follower portion has a cam surface including two symmetric peaks, two symmetric valleys, and slopes connected the peaks and valleys, the valleys are adjacent to the mounted portion.
